(19) United States
(12) Patent Application Publication
(10) Pub. No.: US 2022/0305526 A1
(43) Pub. Date: Sep. 29, 2022

(54) COATING METHOD AND COATING FILM CURING APPARATUS

(71) Applicant: HONDA MOTOR CO., LTD., Tokyo (JP)

(72) Inventors: Masayuki Yamaguchi, Tokyo (JP); Yoshitaka Tsujii, Tokyo (JP)

(21) Appl. No.: 17/673,897

(22) Filed: Feb. 17, 2022

(30) Foreign Application Priority Data
Mar. 23, 2021 (JP) 2021-048861

(51) Int. Cl. B05D 3/06; B05D 3/00; B05D 1/04; B05B 13/04

(52) U.S. Cl. CPC B05D 3/068; B05D 3/007; B05D 1/04; B05B 13/0431

(57) ABSTRACT

A coating method includes a coating step of applying coating material to a workpiece, and a curing step of curing the coating material by irradiating the applied coating material with an electron beam emitted from an electron beam irradiation unit, wherein in the curing step, a potential of the workpiece is higher than a potential of the electron beam irradiation unit.

### CROSS-REFERENCE TO RELATED APPLICATIONS

This application is based upon and claims the benefit of priority from Japanese Patent Application No. 2021-048861 filed on Mar. 23, 2021 the contents of which are incorporated herein by reference.

### BACKGROUND OF THE INVENTION

### Field of the Invention

The present invention relates to a coating method and a coating film curing apparatus.

### Description of the Related Art

A coating method for curing coating material on a workpiece by irradiating the coating material applied to the workpiece with electron beam is known. For efficient treatment and uniform curing of the coating material, it is preferable to uniformly and efficiently irradiate the coating material on the workpiece with the electron beam. However, the electron beam tends to spread radially. This is because charge repulsion acts between electrons constituting the electron beam. Therefore, the electron beam is easily irradiated also to a position other than the target position. That is, it is not easy to efficiently irradiate the workpiece with the electron beam. Further, depending on the shape of the workpiece, efficient irradiation of the electron beam becomes more difficult.

JP 4715018 B2 discloses a technique for uniformly irradiating an object with an electron beam using a deflector constituted by an electromagnetic lens. However, the deflector has certain restrictions on the range in which the electron beam can be deflected. In particular, when the workpiece has a three dimensional shape, it is difficult to appropriately set the position and orientation of the deflector with respect to the workpiece. That is, it is not easy to efficiently irradiate a three dimensional workpiece with an electron beam using a deflector.

### SUMMARY OF THE INVENTION

Efficient irradiation of coat material applied to a workpiece with an electron beam is a problem. An object of the present invention is to solve the above-mentioned problem.

A coating method according to one aspect of the present invention includes a coating step of applying coating material to a workpiece, and a curing step of curing the coating material by irradiating the applied coating material with an electron beam emitted from an electron beam irradiation unit, wherein in the curing step, the potential of the workpiece is higher than the potential of the electron beam irradiation unit.

A coating film curing apparatus according to one aspect of the present invention includes an electron beam irradiation unit that irradiates a coating material applied to a workpiece with an electron beam to cure the coating material, wherein the potential of the workpiece is higher than the potential of the electron beam irradiation unit during the irradiation of the electron beam.

According to the present invention, it is possible to provide a coating method and a coating film curing apparatus capable of efficiently irradiating a coating material applied to a workpiece with electron beams.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram showing a coating film curing apparatus according to an embodiment.

FIGS. 2A and 2B are diagrams showing a state in which electron beams are emitted onto a workpiece from electron beam irradiation units.

FIG. 3 is a flow chart showing a coating method according to an embodiment.

### DESCRIPTION OF THE INVENTION

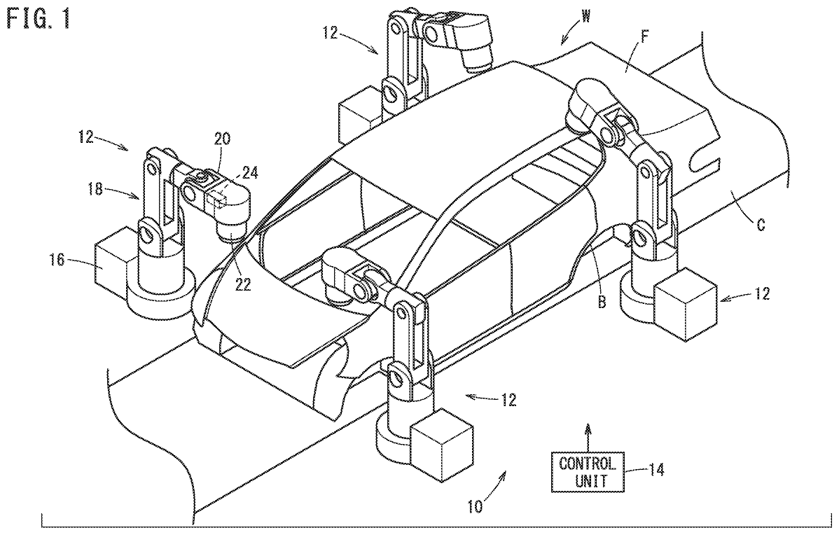

Hereinafter, a coating method and a coating film curing apparatus according to an embodiment of the present invention will be described. FIG. 1 is a diagram showing a coating film curing apparatus 10 according to the embodiment.

The coating film curing apparatus 10 is an apparatus that irradiates a workpiece W with an electron beam. The coating film curing apparatus 10 includes a plurality of electron beam irradiation mechanisms 12 and a control unit 14. Here, for the purpose of efficient processing of the workpiece W, the coating film curing apparatus 10 has four electron beam irradiation mechanisms 12. However, the number of the electron beam irradiation mechanisms 12 may be 1 to 3 or 5 or more.

The workpiece W has a conductive member B and a film of coating material (hereinafter referred to as “coating film”) F. By applying a coating material to the conductive member B, the coating film F is formed on the conductive member B. The coating material (coating film F) is a resin material that is cured by being irradiated with an electron beam. The conductive member B is, for example, a metal body of an automobile. The workpiece W is formed by applying the coating material to the conductive member B. Thereafter, the workpiece W is transferred by a conveyor C and processed by the coating film curing apparatus 10.

Each of the plurality of electron beam irradiation mechanisms 12 has a base 16, a driving unit 18, and a head 20. The base 16 is a base of the electron beam irradiation mechanism 12 and is installed, for example, on a floor of a factory. The driving unit 18 is a mechanism for changing the position and the orientation of the head 20 (and an electron beam irradiation unit 22 described later). The driving unit 18 can be constituted by, for example, a plurality of arms and a plurality of operation mechanisms. The plurality of arms are connected by a plurality of joints. Each of the plurality of operation mechanisms may be, for example, a motor to relatively move or rotate the plurality of arms.

The electron beam irradiation unit 22 is attached to the head 20. The head 20 includes a potential application unit 24. The electron beam irradiation unit 22 cures the coating material by irradiating the coating material on the workpiece W with electron beams. The electron beam irradiation unit 22 generates an electron beam, accelerates the generated electron beam, and further irradiates the workpiece W with the accelerated electron beam. When the electron beam is emitted from the electron beam irradiation unit 22, the potential application unit 24 applies a negative potential to the electron beam irradiation unit 22. This makes it easy to set the potential of the workpiece W higher than the potential of the electron beam irradiation unit 22. That is, without applying a positive potential to the workpiece W, for example, in a state in which the workpiece W is grounded, the potential application unit 24 can make the potential of the workpiece W higher than the potential of the electron beam irradiation unit 22. This will be described in detail later.

The control unit 14 is formed by combining hardware (processor) and software (program), for example. The control unit 14 controls the driving unit 18, the electron beam irradiation unit 22, and the potential application unit 24. The control unit 14 controls the driving unit 18 and the electron beam irradiation unit 22 so that the electron beam can be emitted onto the coating film F onto the workpiece W while the position and orientation of the electron beam irradiation unit 22 are changed so as to follow the surface of the workpiece W.

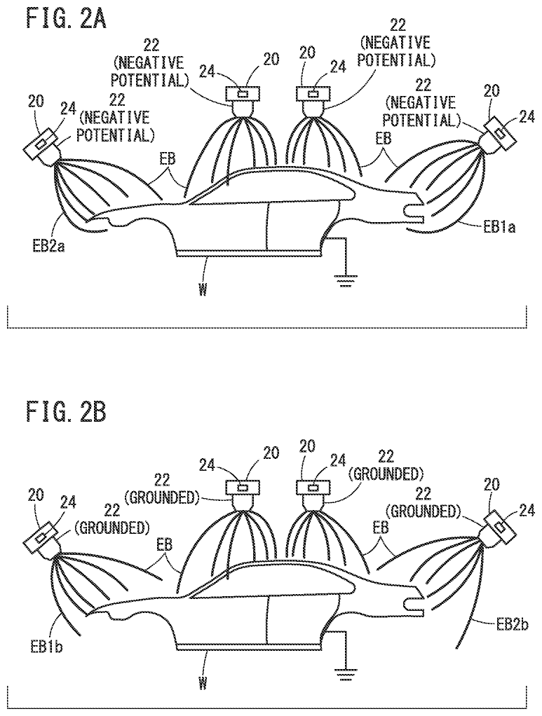

The reason why the potential of the workpiece W is set higher than that of the electron beam irradiation unit 22 by the potential application unit 24 or the like will be described below. FIGS. 2A and 2B are diagrams showing a state in which electron beams EB are emitted onto the workpiece W from the electron beam irradiation units 22. FIG. 2A shows a case in which the workpiece W has a higher potential than the electron beam irradiation unit 22 (hereinafter referred to as a “high-potential case”). Here, the workpiece W is grounded, and a negative potential from the potential application unit 24 is applied to the electron beam irradiation unit 22. FIG. 2B shows a case in which the workpiece W has an equal potential to the electron beam irradiation unit 22 (hereinafter referred to as an “equipotential case”). Here, the workpiece W and the electron beam irradiation unit 22 are grounded.

In both FIGS. 2A and 2B, the electron beam irradiation unit 22 operates, and the electron beams EB are emitted onto the workpiece W from the electron beam irradiation unit 22. In the high-potential case (FIG. 2A), the spread of the electron beam EB is suppressed compared with that in the equipotential case (FIG. 2B). That is, in the high-potential case, the electron beam EB converges. Here, electron beam EB1a and electron beam EB2a (FIG. 2A) are compared with electron beam EB1b and electron beam EB2b (FIG. 2B). The electron beams EB1a, EB2a, EB1b, and EB2b are emitted onto the vicinity of end portions of the workpiece W. As can be seen from this comparison, in the equipotential case, neither the electron beam EB1b nor the electron beam EB2b reaches the workpiece W, whereas in the high-potential case, both the electron beam EB1a and the electron beam EB2a reach the workpiece W. That is, in the high-potential case, the electron beam EB is used more efficiently than in the equipotential case.

When the electron beam EB is emitted (when the coating material is cured), the potential of the workpiece W is set higher than that of the electron beam irradiation unit 22. Thus, the electron beam EB made up from electrons having negative charge is attracted to the workpiece W. Eventually, the electron beams EB converge. As a result, the electron beams EB are efficiently and intensively emitted onto the workpiece W. That is, the utilization efficiency of the electron beams EB is improved.

In addition, the electron beam EB (electrons) is accelerated by the potential difference between the electron beam irradiation unit 22 and the workpiece W. That is, the electron beam EB (electrons) at the time of reaching the coating material (coating film F) on the workpiece W is in a more accelerated state than the electron beam EB (electrons) at the time of being emitted from the electron beam irradiation unit 22. Because the coating material is irradiated with the electron beams EB of higher energy, the coating material becomes harder.

Further, since the workpiece W is an automobile body or the like, the surface of the workpiece W, which is a design surface, has a three dimensional shape. For this reason, the workpiece W has a portion (shadow portion) that becomes a shadow when viewed from the electron beam irradiation unit 22. The potential of the workpiece W is made higher than that of the electron beam irradiation unit 22, whereby the electron beams EB are attracted to the workpiece W and as a result, the electron beams EB converge. Therefore, part of the electron beams EB bend around the workpiece W and further are emitted onto the shadow portion of the workpiece W described above. As a result, the workpiece W having the three dimensional shape is efficiently and uniformly irradiated with the electron beams EB.

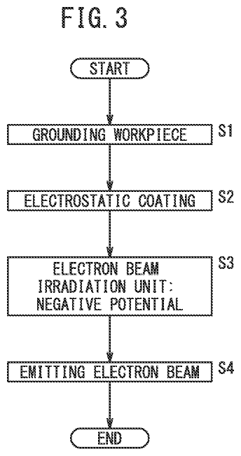

Hereinafter, a coating method according to the present embodiment will be described. FIG. 3 is a flow chart showing the coating method according to the embodiment. The coating method according to the embodiment includes a step of grounding the workpiece W (step S1), an electrostatic coating step (step S2), a negative potential application step (step S3), and an electron beam irradiation step (step S4).

In the step of grounding the workpiece W, the conductive member B (here, a metal body of an automobile) constituting the workpiece W is grounded. Thereafter, in the electrostatic coating process, the negative potential application process, and the electron beam irradiation process, this grounding is maintained. As a result, as will be described later, efficient electrostatic coating and efficient electron beam irradiation become possible.

In the electrostatic coating process, for example, an electrostatic spray gun is used to generate charged particles (fog) of the coating material and spray the generated fog onto the workpiece W. As a result, the coating material is applied to the workpiece W. At this time, the workpiece W is in a grounded state because of the grounding process. Therefore, the charged (particles of) coating material having reached the workpiece W returns to a uncharged state, and the application of the coating material proceeds. If the workpiece W is not grounded, the accumulation of electric charge on the workpiece W increases as the application of the coating material proceeds. The accumulation of electric charge on the workpiece W prevents the charged particles of the coating material from reaching the workpiece W and ultimately prevents the application of the coating material.

In the negative potential application step, the potential application unit 24 applies a negative potential to the electron beam irradiation unit 22. As a result, the potential of the grounded workpiece W becomes higher than that of the electron beam irradiation unit 22. In this manner, by combining the grounding of the workpiece W and the application of the negative potential to the electron beam irradiation unit 22, the potential of the workpiece W can be reliably made higher than the potential of the electron beam irradiation unit 22.

Further, by applying a negative potential to the electron beam irradiation unit 22 in the negative potential application process, it is possible to efficiently shift from the electrostatic coating process to the electron beam irradiation process. That is, the process can be shifted from the electrostatic coating process to the electron beam irradiation process while the workpiece W remains grounded. Here, the potential of the workpiece W can be made higher than the potential of the electron beam irradiation unit 22 by applying a positive potential to the workpiece W instead of applying a negative potential to the electron beam irradiation unit 22. In this case, however, it is necessary to release the grounding of the workpiece W before applying a positive potential to the workpiece W. Therefore, the process becomes complicated.

In the electron beam irradiation step, in a state where the workpiece W is grounded and a negative potential is applied to the electron beam irradiation unit 22, the coating material on the workpiece W is irradiated with the electron beam EB from the electron beam irradiation unit 22. As a result, the coating material is cured by the electron beam EB. At this time, the potential of the workpiece W is higher than that of the electron beam irradiation unit 22. Therefore, the electron beam EB from the electron beam irradiation unit 22 is efficiently emitted onto the workpiece W. As a result, the coating material is cured efficiently.

In a case where the workpiece W has a three dimensional shape, it is preferable that the control unit 14 controls the driving unit 18 and the electron beam irradiation unit 22 to irradiate the coating material with the electron beam EB while changing the position and orientation of the electron beam irradiation unit 22 along the surface of the workpiece W. As a result, it is possible to further improve the uniformity of electron beam irradiation on the workpiece W having a three dimensional shape, as compared with a case where the electron beam irradiation unit 22 is fixed.

Here, by performing the grounding of the workpiece W (step S1), the electrostatic coating (step S2), and the electron beam irradiation (step S4) in this order, efficient processing can be performed. That is, after the workpiece W is grounded, electrostatic coating and electron beam irradiation can be performed without changing the grounded state.

As described above, in the present embodiment, by efficiently irradiating the coating film F on the workpiece W with the electron beam EB, the coating film F can be cured efficiently. In particular, when the workpiece W has a three dimensional shape, the uniformity of electron beam irradiation onto the workpiece W can be improved.

### Modification

A modification of the present embodiment will be described. Although the electrostatic coating is used in step S2 in this embodiment, a method other than the electrostatic coating may be used. For example, a coating material may be applied to the workpiece W by a common spray gun. In this case, the workpiece W is sprayed with a fog of uncharged coating material. Therefore, the grounding step (step S1) may be performed after coating instead of before coating.

In this embodiment, the workpiece W is grounded and a negative potential is applied to the electron beam irradiation unit 22. Thus, the potential of the workpiece W is set higher than that of the electron beam irradiation unit 22. However, other techniques may be used. An example of other techniques is to apply a positive potential to the workpiece W. In this case, the electron beam irradiation unit 22 may be grounded without applying a negative potential to the electron beam irradiation unit 22.

### Invention Obtained from Embodiment

The invention that can be understood from each of the above embodiments will be described below.
[1] The coating method including the coating step (S2) of applying the coating material to the workpiece (W), and the curing step (S3) of curing the coating material by irradiating the applied coating material (coating film F) with the electron beam (EB) emitted from the electron beam irradiation unit (22), wherein in the curing step, the potential of the workpiece is higher than the potential of the electron beam irradiation unit. Thus, the workpiece can be efficiently irradiated with the electron beam.
[2] In the curing step, the negative potential is applied to the electron beam irradiation unit. This makes it possible to make the potential of the workpiece W higher than the potential of the electron beam irradiation unit in a state where the workpiece is grounded.
[3] The workpiece includes the conductive member (B), and the coating step includes the step (S1) of grounding the conductive member of the workpiece, and the step (S2) of applying the coating material to the workpiece by spraying the workpiece with the charged particles of the coating material onto the workpiece, wherein in the curing step, the ground state of the workpiece is maintained. As a result, electrostatic coating and electron beam irradiation can be performed while the grounded state of the workpiece is maintained, and workpiece efficiency is improved.
[4] The workpiece has a three dimensional shape, and in the curing step, the electron beam irradiation unit irradiates the coating material with the electron beam while changing the position and orientation of the electron beam irradiation unit along the surface of the workpiece. This makes it possible to improve the uniformity of electron beam irradiation on the workpiece W having a three dimensional shape.
[5] The coating film curing apparatus (10) includes the electron beam irradiation unit (22) that irradiates the coating material applied to the workpiece (W) with the electron beam (EB) to cure the coating material, and when the electron beam is emitted, the potential of the workpiece is higher than the potential of the electron beam irradiation unit. Thus, the workpiece can be efficiently irradiated with the electron beam.
[6] The coating film curing apparatus includes the potential application unit (24) that applies the negative potential to the electron beam irradiation unit during the irradiation of the electron beam. This makes it possible to make the potential of the workpiece higher than the potential of the electron beam irradiation unit in a state where the workpiece is grounded.
[7] The coating film curing apparatus includes the driving unit (18) that changes the position and orientation of the electron beam irradiation unit, and the control unit (14) that controls the electron beam irradiation unit and the driving unit to irradiate the coating material with the electron beam while the position and orientation of the electron beam irradiation unit are changed along the surface of the workpiece. Thus, the workpiece can be efficiently irradiated with the electron beam.

The present invention is not limited to the above-described embodiment, and various modifications can be made without departing from the gist of the present invention.

What is claimed is:

1. A coating method comprising:
a coating step of applying coating material to a workpiece;
a curing step of curing the coating material by irradiating the applied coating material with an electron beam emitted from an electron beam irradiation unit;
wherein
in the curing step, a potential of the workpiece is higher than a potential of the electron beam irradiation unit.

2. The coating method according to claim 1, wherein
in the curing step, a negative potential is applied to the electron beam irradiation unit.

3. The coating method according to claim 2, wherein
the workpiece includes a conductive member,
the coating step includes:
a step of grounding the conductive member of the workpiece; and
a step of applying the coating material to the workpiece by spraying the workpiece with charged particles of the coating material,
in the curing step, a grounded state of the workpiece is maintained.

4. The coating method according to claim 1, wherein
the workpiece has a three dimensional shape, and
in the curing step, the coating material is irradiated with the electron beam while a position and an orientation of the electron beam irradiation unit are changed along a surface of the workpiece.

5. A coating film curing apparatus comprising an electron beam irradiation unit that irradiates coating material applied to a workpiece with an electron beam to cure the coating material,
wherein when the electron beam is emitted, a potential of the workpiece is higher than a potential of the electron beam irradiation unit.

6. The coating film curing apparatus according to claim 5, further comprising a potential application unit that applies a negative potential to the electron beam irradiation unit during emission of the electron beam.

7. The coating film curing apparatus according to claim 5, further comprising:
a driving unit that changes a position and an orientation of the electron beam irradiation unit; and
a control unit that controls the electron beam irradiation unit and the driving unit to irradiate the coating material with the electron beam while the position and the orientation of the electron beam irradiation unit are changed along a surface of the workpiece.
